(19) United States
(12) Patent Application Publication
(10) Pub. No.: US 2002/0081369 A1
(43) Pub. Date: Jun. 27, 2002

(54) Seafood product

(76) Inventor: James Fletcher, Manns Harbor, NC (US)

Correspondence Address: Larry J. Guffey, World Trade Center, Suite 1800, 401 East Pratt Street, Baltimore, MD, 21202, US

(21) Appl. No.: 09/995,110

(22) Filed: Nov. 27, 2001

Related U.S. Application Data
(60) Provisional application No. 60/253,267, filed on Nov. 27, 2000.

(51) Int. Cl. A23L 1/325

(52) U.S. Cl. 426/643

(57) ABSTRACT

A method for making a simulated crustacean-meat product is disclosed. In a preferred embodiment for making a simulated crab-meat product, this method comprises the steps of: (1) providing a supply of “dry” scallop adductor muscles or scallop meat, (2) exerting forces on the surfaces of these muscles so as to break them along their natural lines of separation so as to form smaller, natural pieces that are comparable in volume to that of the crab-meat whose appearance the smaller, natural pieces are intended to simulate, and (3) cooking these smaller, natural pieces in a manner similar to that used to cook the crab-meat whose taste and feel is to be simulated by these smaller, natural pieces.

### CROSS-REFERENCE TO RELATED APPLICATION

This application is related to U.S. Provisional Patent Application No. 60/253,267, filed on Nov. 27, 2000 by James C. Fletcher and entitled, “Seafood Product.” The teachings of this application is incorporated herein by reference to the extent that it does not conflict with the teaching herein.

### BACKGROUND OF THE INVENTION

1. Field of Invention

This invention relates generally to processed seafood products and methods for their preparation. More particularly, this invention relates to methods for making imitation or simulated crustacean-meat products.

2. Description of the Related Art

Imitation shellfish products, such as fish sticks or fillets made from simulated crab, shrimp or lobster, are a significant segment of the seafood product industry. Such products usually result from processes wherein less expensive or underutilized fish or seafood varieties are converted into products with the form and taste of more desirable seafood varieties.

The most prevalent examples of imitation shellfish products are those derived from surimi. Surimi is a form of minced fish flesh which has been processed to remove water soluble proteins. The minced flesh that remains is surimi. It is comprised of water insoluble proteins, largely in the form of short muscle fibers. When the surimi is ground or minced into a finely comminuted paste in the presence of salt, the surimi turns into a sticky paste having gel-forming characteristics, as the salt aids in extracting otherwise insoluble proteins from the muscle fibers. When subsequently heated, the proteins thus extracted into the paste will denature and form a gel. Other additives in addition to salt can be incorporated into the paste, and these often include flavorings derived from or reminiscent of the seafood variety to be duplicated. The final shape of the product is thus dictated by whatever mold or form it occupies at the point when the surimi paste is solidified. See U.S. Pat. Nos. 4,158,065, 4,371,560, 4,692,341, 4,824,687, 4,855,158, 5,028,445, 5,145,701, and 5,254,352.

Although the general nature of shellfish sticks and fillets may be duplicated with surimi pastes, the flakiness or forkability and taste of the basic shellfish, body meats has not yet been achieved with existing surimi processes. This presents a significant opportunity for the development of new, imitation or simulated, shellfish products, especially for imitation or simulated, hand-picked, crab meats which enjoy a large market throughout the world.

In general, the prior art yields imitation seafood products that differ greatly in structure, texture and taste from natural, hand-picked crustacean-meats. Thus, despite this prior art, the need exists for imitation or simulated, cooked, hand-picked, crustacean-meats.

### SUMMARY OF THE INVENTION

I have discovered that it is possible to prepare reformed, mollusk products having the physical and taste properties of the natural, hand-picked meats of the crustaceans which feed upon the mollusks. In accordance with one preferred embodiment of the present invention, a method for making an imitation or simulated crustacean-meat product is disclosed. This method comprises the steps of: (1) providing a supply of “dry” scallop adductor muscles or scallop meat, (2) exerting tangential forces on the surfaces of these muscles so as to break them along their natural lines of separation so as to form smaller, natural pieces that are comparable in volume to that of the typical crustacean-meat whose taste the smaller, natural pieces are intended to imitate or simulate, and (3) cooking these smaller, natural pieces in a manner similar to that used to cook the crustacean-meat whose taste is to be imitated or simulated by these smaller, natural pieces.

Thus, there has been summarized above, rather broadly, the more important features of the present invention in order that the detailed description that follows may be better understood and appreciated. There are, of course, additional features of the invention that will be described hereinafter and which will form the subject matter of any eventual claims to this invention.

In this respect, before explaining at least one embodiment of the present invention in detail, it is to be understood that the invention is not limited in its application to the details of the methods described herein. The invention is capable of other embodiments and of being practiced and carried out in various ways. Also, it is to be understood that the phraseology and terminology employed herein are for the purpose of description and should not be regarded as limiting.

It is therefore an object of the present invention to provide a process for producing formed seafood products in a variety of heretofore unavailable forms.

A more specific object is to provide imitation or simulated seafood products which duplicate the form, feel and taste of cooked, hand-picked crustacean meats.

Another object is to provide a method for using less expensive, scallop adductor muscles to produce more expensive, imitation or simulated, hand-picked, crab meats.

A further object is to provide products of scallop adductor muscles which duplicate the form, feel and taste of cooked, hand-picked crustacean meats.

A still further object is to provide a method for producing imitation or simulated crustacean-meat products where the texture and taste of the final product is improved by utilizing as a starting material those species of mollusks upon which the crustacean is known to feed.

These and other objects and advantages of the present invention will become readily apparent as the invention is better understood by reference to the accompanying drawings and the detailed description that follows.

### BRIEF DESCRIPTION OF THE DRAWINGS

FIG. 1 illustrates the interior of a scallop after its top shell has been removed to reveal its two adductor muscles.

FIG. 2 presents a schematic representation of the structural units (sarcomeres) of typical striated muscle fiber.

FIG. 3 (a)-(d) illustrate the fiber microanatomy of a scallop's striated adductor muscle.

Table I lists the various potential commercial scallops, all of which may be included within various embodiments of the present invention.

FIG. 4 demonstrates the breaking of Atlantic sea scallops (a) to simulate the cooked appearance of lump crab meat in the plate on the right and regular crab meat in the plate on the left in (b).

### DESCRIPTION OF THE PREFERRED EMBODIMENT

In a preferred embodiment of the present invention, a method is disclosed for using scallop adductor muscles to produce imitation or simulated, hand-picked, crab meats. To understand how this might be possible, it is instructive to examine the structure and biochemistry of scallops.

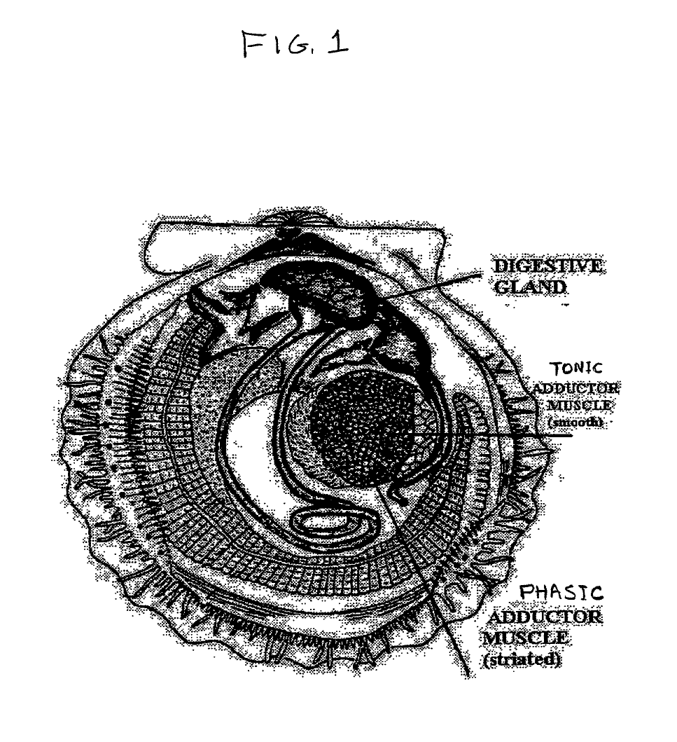

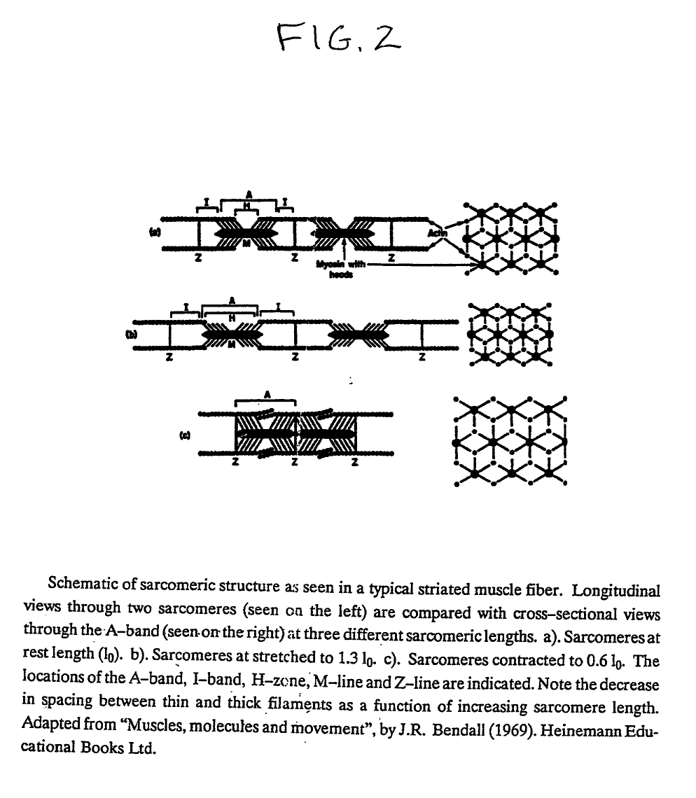

Scallops are bivalve mollusks with two, hinged, scallop-edged, fan-shaped values (shells) which can be rapidly closed to enable the scallop to swim by ejecting water from the cavity formed between its shells. FIG. 1 shows the simulated interior of a scallop after its top shell has been removed to reveal its two adductor muscles. Its phasic adductor muscle is the part of the scallop that is most often eaten. It is usually is striated and concerned with the fast, repetitive opening and closing of the scallop's shells. It's tonic adductor muscle, which is eaten less often (possibly because of its high paramyosin content which gives the muscle a somewhat chewy texture), is smooth and is more concerned with keeping the scallop's shells closed for extended periods of time. In most scallops, the two type of adductor muscles lie close to one another and there is often a gradual transition of muscle fiber type from one muscle to the next.

Investigators of the microstructure and biochemistry of scallop striated, adductor muscles have found that these muscles contract by a sliding filaments mechanism; with thin filaments sliding past thick filaments. See FIG. 2. Each thick filament is packed in a hexagonal array and is surrounded by twelve thin filaments, with the thick filaments containing myosin (the commonest protein in muscle cells) and some paramyosin (but much less than the tonic adductor muscles), and with the thin filaments containing actin (the protein that reacts with myosin to help provide the muscle's elastic and contractile properties).

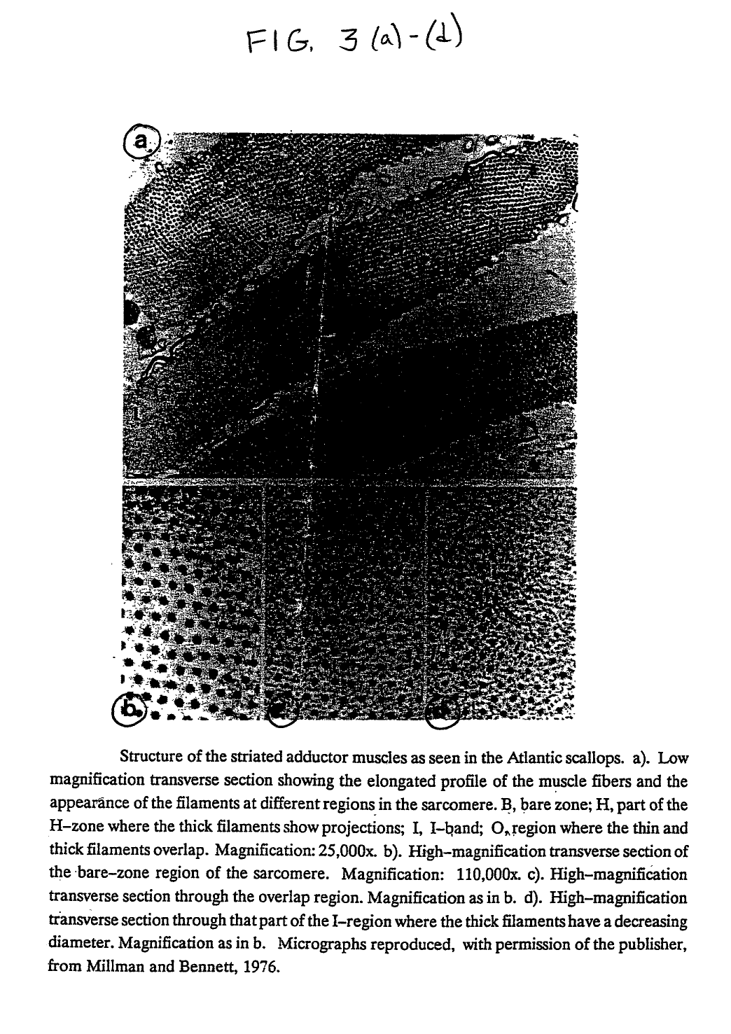

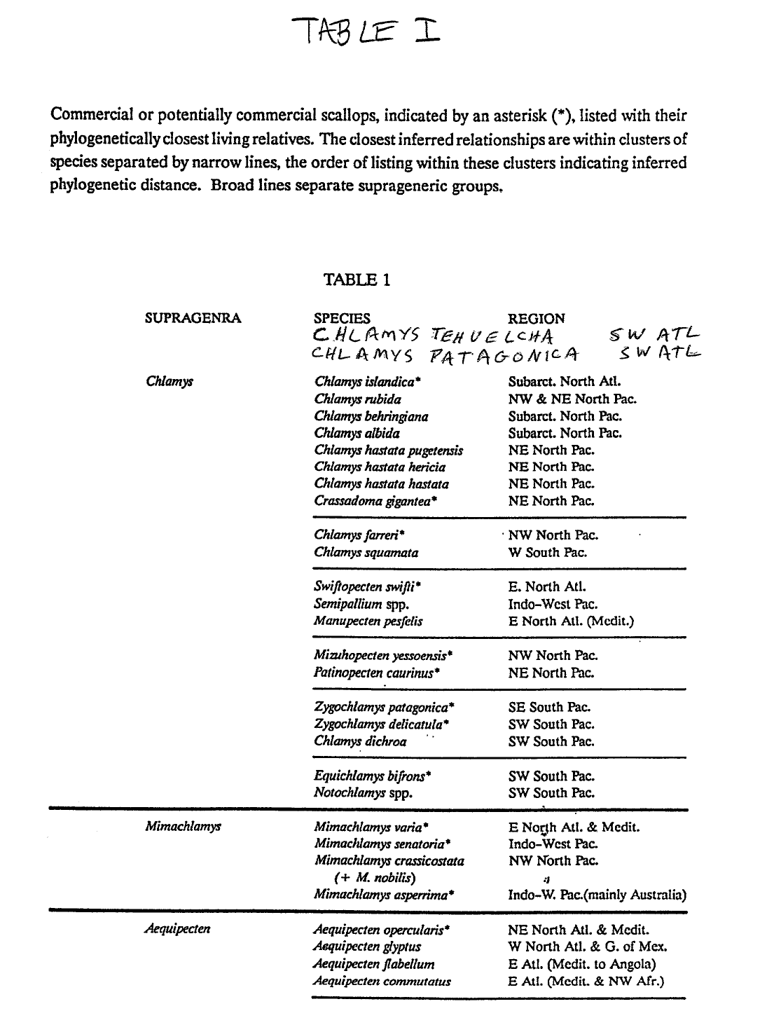

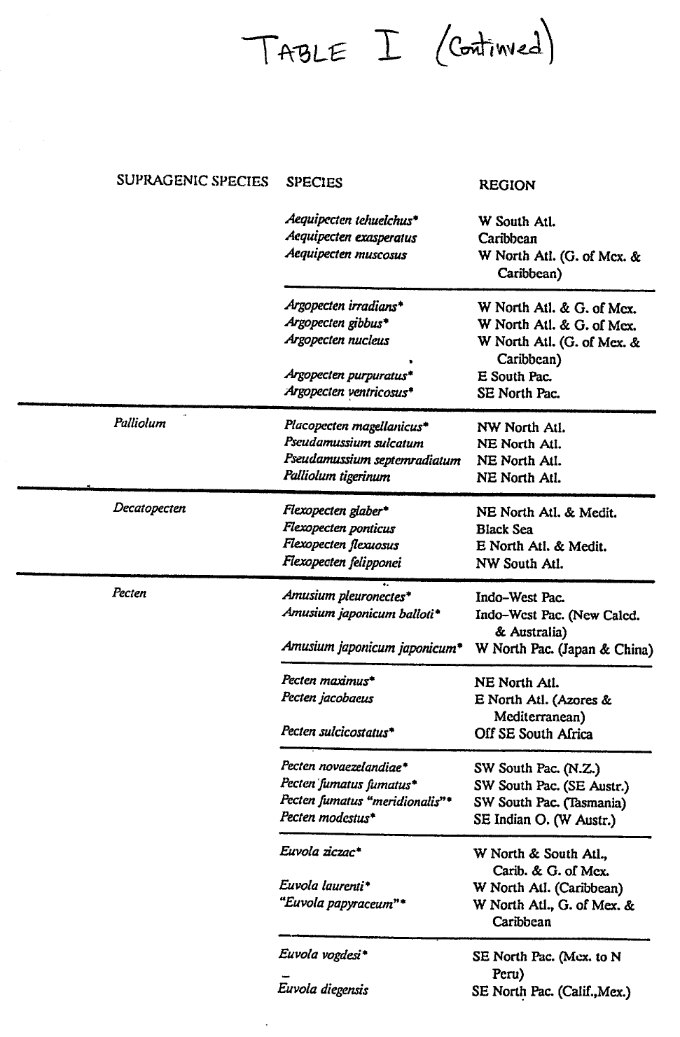

Each cell of the muscle is relatively small and ribbon-like (See FIG. 3(a)-(d)). These muscle cells are seen to be shorter than the length of the muscle and to contain a single, centrally-placed filament or myofibril which is bounded by a surface membrane. Peripheral couplings with the surface membrane are formed from a complex sarcoplasmic network, the composition of which appears to comprise a near-crystalline array of dimer ribbons of Ca++-ATPase molecules.

The unique anatomy and biochemistry of the scallop have led to rather universal, commercial fishing methods having been adopted for them. Scallops are harvested primarily by dredging. Since scallops cannot hold their shells closed for extended periods of time, once they are out of water, they relatively quickly lose their water and die. Consequently, they're shucked on board the ships, place in containers, and refrigerated.

Additionally, these scallops are further processed by soaking them in water to add salable weight. Ingredients, such as tripolyphosphate, salt, baking soda, polyphosphates, and citric acid, are also added to these mixtures to help the scallops retain water.

Such “soaked” or further processed scallops have been found to be unacceptable for use with the methods of the current invention. Only “dry” (unprocessed) scallop striated adductor muscles are suitable for use with the methods of the current invention.

I have found that such “dry” scallop, striated adductor muscles have natural planes of separation which allow them to be easily separated into smaller, natural pieces by the application of relatively small levels of shear stresses to the muscles' outer surfaces. Furthermore, I have found that these smaller, natural pieces have, after cooking, a taste that is quite different than that which is found by similarly cooking the original “dry” muscles.

From the separation of many species of “dry” scallop, striated adductor muscles, I have found that the taste of these cooked, smaller, natural pieces is best characterized by comparing it to that of the taste recognized in the cooked meat of the crustaceans from the same region as that of the scallops. Furthermore, I have theorized that there may exist a general axiom which characterizes this finding for various seafood: “the taste of the unprocessed muscles of a preyed upon species, after these muscles first have been separated into smaller pieces by the application of shear stresses to the surfaces of the muscles and then after the resulting pieces have been cooked, will be comparable to that of the taste of the cooked meat of that particular predator seafood which is know to feed upon the species in question.”

Thus for crustaceans, I have deduced that the taste of the crab-meat from a region of the world is a reflection of the mollusks upon which the crustacean feeds (e.g., Maine lobsters-Atlantic sea scallops). See Table I for a listing of potentially commercial scallops.

I have found that many different techniques can be employed to accomplish the separation of“dry” scallop, striated adductor muscles. These include various methods for applying sufficient shear stresses to the surfaces of the muscles:

(1) two cooperating, parallel rollers having a separation gap between the rollers which is set at a height which is less than that of the diameter of the muscles to be separated and rotating so as to pull the muscles between the rollers,

(2) an extruder consisting of a cylinder and plunger mechanism, where the diameter of the cylinder is less than the diameter of the muscles to be separated, with the plunger forcing the muscles through the cylinder, and

(3) a conveyor belt on which the muscles lie as they are conveyed beneath an upper surface which is set at a height above the conveyor belt which is less than the diameter of the muscles to be separated.

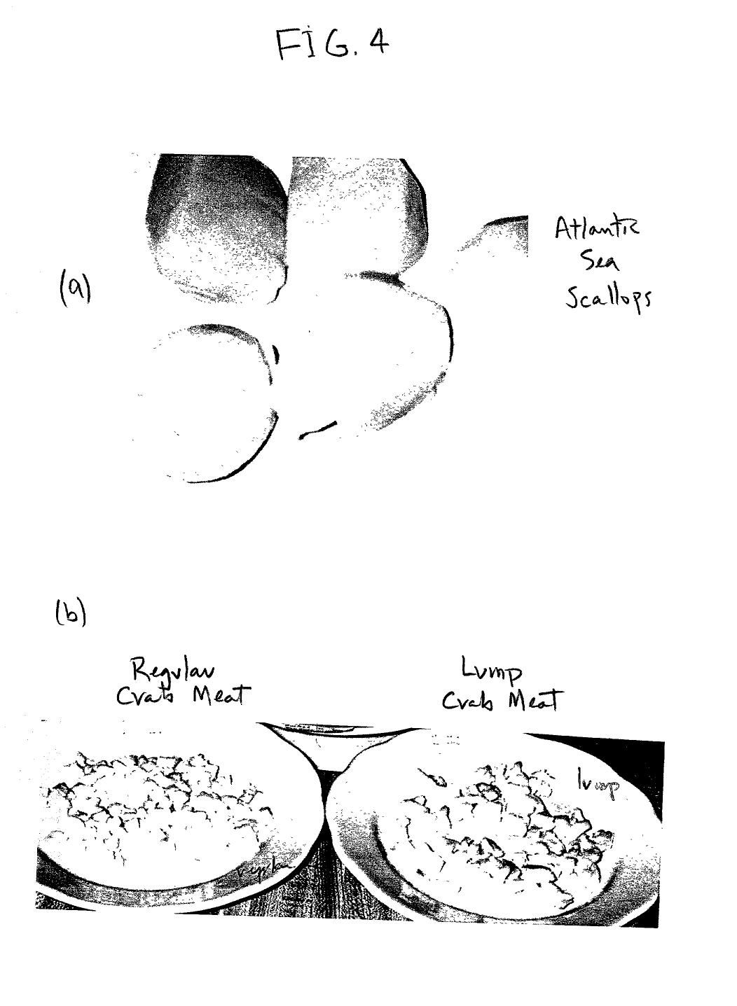

FIG. 4 demonstrates the results that can be achieved using such methods. FIG. 4(a) shows the form of a typical Atlantic sea scallop, and FIG. 4(b) shows the results of breaking these scallops so that they simulate the cooked appearance of lump crab meat in the plate on the right and regular crab meat in the plate on the left.

Similarly, I have found that many different means may be used to cooked these smaller, natural pieces of “dry” scallop, striated adductor muscles, including using boiling, steam, dry heat, micro-wave heating, radiation heating, frying, sauteing and other FDA approved cooking methods. The time and temperature needed to cook the various species depends on the size of the separated pieces and the cooking methods used for the predator crustacean whose taste is to be imitated or simulated by these smaller, natural pieces of adductor muscles. Since these cooking methods are well known in the industry, they are not discussed further herein.

Although the foregoing disclosure relates to a preferred embodiment of the invention, it is understood that these details have been given for the purposes of clarification only. Various changes and modifications of the invention will be apparent, to one having ordinary skill in the art, without departing from the spirit and scope of the present invention.

I claim:

1. A method for making a taste- and appearance-simulated, crustacean-meat product which comprises the steps of:
providing a supply of the edible meat of the primary mollusk that is fed upon by said crustacean whose meat is to be simulated,
exerting forces on the surfaces of said edible, mollusk meat so as to form smaller, natural pieces that are comparable in volume to that of the typical crustacean-meat whose taste and appearance said smaller, natural pieces are intended to simulate, and
cooking said smaller, natural pieces in a manner similar to that used to cook the crustacean-meat whose taste and appearance is to be simulated by said smaller, natural pieces.

2. A method as recited in claim 1 wherein said supply of edible, mollusk meat is fresh and dry in that said meat has not been soaked in a water solution.

3. A method as recited in claim 2 wherein said crustacean-meat product is crab meat and the mollusk fed upon by said crab is a scallop whose adductor muscles form its edible meat.

4. A method as recited in claim 3 wherein said surface forces are applied to said scallop adductor muscles so as to break them along their natural lines of separation.

5. A method as recited in claim 2 wherein said crustacean-meat product is Maine lobster meat and the mollusk fed upon by said lobster is an Atlantic sea scallop whose adductor muscles form its edible meat.

6. A method as recited in claim 5 wherein said surface forces are applied to said scallop adductor muscles so as to break them along their natural lines of separation.

7. A seafood product that simulates the appearance, feel and taste of a specified cooked, hand-picked crustacean meat, said seafood product comprising:
an edible meat of the primary mollusk that is fed upon by said specified crustacean whose meat is to be simulated,
wherein said edible, mollusk meat having been broken so as to form smaller, natural pieces that are comparable in volume to that of said specified, crustacean-meat whose appearance said smaller, natural pieces are intended to simulate, and
wherein said smaller, natural pieces having been cooked in a manner similar to that used to cook said specified, crustacean-meat whose taste and feel is to be simulated by said smaller, natural pieces.

8. A seafood product as recited in claim 7 wherein said supply of edible, mollusk meat is fresh and dry in that said meat has not been soaked in a water solution.

9. A seafood product as recited in claim 8 wherein said crustacean-meat product is crab meat and the mollusk fed upon by said crab is a scallop whose adductor muscles form its edible meat.

10. A seafood product as recited in claim 9 wherein said surface forces are applied to said scallop adductor muscles so as to break them along their natural lines of separation.

11. A seafood product as recited in claim 8 wherein said crustacean-meat product is Maine lobster meat and the mollusk fed upon by said lobster is an Atlantic sea scallop whose adductor muscles form its edible meat.

12. A seafood product as recited in claim 11 wherein said surface forces are applied to said scallop adductor muscles so as to break them along their natural lines of separation.

13. A method for making a seafood product which simulates the appearance, feel and taste of a specified cooked, hand-picked crustacean meat, said method comprising the steps of
providing a supply of the edible meat of the primary mollusk that is fed upon by said crustacean whose meat is to be simulated,
exerting forces on the surfaces of said edible, mollusk meat so as to break them along their natural lines of separation so as to form smaller, natural pieces that are comparable in volume to that of the typical crustacean-meat whose appearance said smaller, natural pieces are intended to simulate, and
cooking said smaller, natural pieces in a manner similar to that used to cook the crustacean-meat whose taste and feel is to be simulated by said smaller, natural pieces.
